(19) United States
(12) Patent Application Publication
(10) Pub. No.: US 2009/0040495 A1
(43) Pub. Date: Feb. 12, 2009

(54) ILLUMINATION SYSTEM INCLUDING AN OPTICAL FILTER

(75) Inventor: Markus Schwab, Wohnsitz (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/058,173

(22) Filed: Mar. 28, 2008

Related U.S. Application Data
(63) Continuation of application No. PCT/EP2006/009498, filed on Sep. 30, 2006.
(60) Provisional application No. 60/723,067, filed on Oct. 3, 2005.

(51) Int. Cl. G03B 27/72

(52) U.S. Cl. 355/71

(57) ABSTRACT

An illumination system including an optical element, such as an optical filter, which can influence the optical properties of radiation impinging thereon is disclosed. Such a filter can have a variably adjustable absorption. The illumination system is employed for instance within a lithography apparatus. A method for the production of microelectronic components and an optical element influencing the optical properties of radiation impinging thereon are also disclosed.

### CROSS-REFERENCE TO RELATED APPLICATIONS

This application is a continuation of international application PCT/EP2006/009498, filed Sep. 30, 2006, which claims the benefit and priority of U.S. provisional application 60/723,067 filed Oct. 3, 2005. The contents of these applications are incorporated by reference herein in their entirety.

### FIELD

The disclosure relates to an illumination system including an optical element, such as an optical filter, which can influence the optical properties of radiation impinging thereon. Such a filter can have a variably adjustable absorption. The illumination system is employed for instance within a lithography apparatus. The disclosure further relates to a method for the production of microelectronic components and an optical element influencing the optical properties of radiation impinging thereon.

### BACKGROUND

Special demands are commonly placed upon an illumination system used in a projection system of a lithography apparatus or a lithography facility. In addition to the homogeneity of the illumination intensity for a field within the field plane of the illumination system, a specific angular distribution of illumination is typically desired. Furthermore, in general, the exit pupil of the illumination system should be illuminated in a prescribed manner. If the illumination system is connected to a projection system, there are additional considerations with respect to illumination to fulfill the desired telecentricity of the subsequent projection system.

### SUMMARY

In some embodiments, the disclosure provides an illumination system including an optical element, such as a filter, for adjusting the intensity in a field plane or a plane conjugated to a field plane and/or a pupil plane or a plane conjugated to a pupil plane in the illumination system. In some embodiments, the optical system is an illumination system of a projection exposure apparatus. The optical element typically includes an at least partially hollow body.

The at least partially hollow body can be at least partially transparent for radiation within the illumination system. A transparent body according to this disclosure is a body which can have a transmission more than 60% (for example, more than 70%, greater than 90%, greater than 95%, greater than 99%, greater than 99.9%) depending on the wavelength used in the optical system. For example in a DUV projection exposure apparatus, in which the optical element (e.g., a filter) can be employed the wavelength used is, for example, 157 nm or 193 nm. In an EUV-projection exposure system the wavelength is commonly 13.5 nm.

Inside the at least partially hollow body is a fluid medium. One or more optical properties of radiation impinging onto the optical element are at least partially changed by the fluid medium.

The system also includes a device for locally influencing the fluid medium in order to adjust the optical property of the light impinging onto the optical element locally.

In some embodiments, the optical property which is changed is the transmission of the radiation impinging onto the optical element. The transmission can be changed if, for example, a so called absorption medium flows through the interior of the hollow body. By locally changing for example the absorption of the absorption medium the transmittance for light impinging onto the optical element can be adjusted. Such a filter is therefore also called an absorption filter.

In certain embodiments, the optical property of light impinging onto the optical element which is changed can be the reflectivity. This can be the case, for example, for a system working with EUV radiation.

In some embodiments, the optical property of the light impinging onto the optical element which is changed is the polarization. If, for example, the polarization of the medium is changed locally, this can influence the polarization properties of light impinging onto the optical element. Such an optical element is therefore called a polarizer.

In certain embodiments, a filter is used to correct nonuniformity in a field illumination in an illumination system with a high degree of flexibility. For example, the filter can be adjusted to change the field illumination.

Furthermore, in addition to enhancing uniformity across the field plane, the illumination system provided with such a filter can appropriately illuminate the exit pupil of the illumination system. Therefore, the filter can help ensure that the desired telecentricity in a projection system positioned after the illumination system in a lithography facility is fulfilled.

The inventors have recognized that the optical properties, for example the absorption properties of a filter, can be adjusted with a high degree of variability if a fluid medium, such as a fluid absorption medium, flows through the filter. The optical properties, for example the absorption properties, then can be adjusted locally. This makes it possible, for example, to locally adjust, for example, the transmission of a beam passing through the filter.

In some embodiments, a carrier medium can be used whereby the concentration of a substance is set to modify the absorption properties such that the radiation employed in the illumination system is at least partially absorbed by the substance. Depending on the wavelength range of the radiation employed, there are various absorbent solid-state particles or absorbent liquids and gases available.

It is also possible to employ ions to absorb radiation. Due to their electrical charge there is also the additional option of activating the ions in a resting electrolyte using electrical fields. In this case it is only the ions absorbing the radiation that pass through the filter in accordance with the disclosure. In the present disclosure this is also referred to as a fluid absorption medium. Alternatively, gases can be employed as an absorption medium

In some embodiments, a fluid filter is provided including a fluid, which changes the polarization state of light impinging onto the filter. Such a filter is also called a fluid polarization filter. A fluid substance which can change the polarization state of light is for example a liquid crystal, such as a liquid crystalline polymer.

In some embodiments, the illumination system is designed for use in a scanning lithography apparatus. During use of such an apparatus, an object to be imaged, typically a reticle, is moved across the field within the field plane illuminated by the illumination system, with a photoresist-coated wafer being synchronously moved and exposed correspondingly within the image plane of the projection system.

The direction of movement of the object to be illuminated within the field plane is hereinafter referred to as the scanning direction or scan direction.

In the case of scanning lithography systems it can be desirable to correct the field-dependent illumination intensity in a direction that is perpendicular to the scanning direction. A device for adjusting the illumination in a direction perpendicular to the scanning direction in a scanning lithography system is described, for example, in WO2005/040927. If an optical element, such as a filter, is employed in a scanning lithography system to correct the field dependent illumination intensity in a direction perpendicular to the scanning direction, consequently, the absorption characteristic of the filter in accordance with the disclosure is generally only to be adjusted perpendicular to the scanning direction. In a most simple case, the absorption medium can have only a unidirectional flow. If there is a difference in the concentration of the substances absorbing the radiation in the carrier medium perpendicular to this flow direction, this can result in the desired local absorption differences perpendicular to the scanning direction of the illumination system. A carrier medium according to this disclosure is a medium in which the substances absorbing the radiation are disposed.

Optionally, a guidance system is provided to provide the flow, for example, of the absorption medium in the filter, optionally with a plurality of guidance elements, such as a channel system with a plurality of channels that are arranged in the area of the filter through which the illumination radiation passes. The development of such separate fluid channels makes it possible to specify the absorption properties for each channel individually. Consequently, it is feasible to allocate different absorption media to the individual channels. In the simplest case this is achieved in a uniform carrier medium by having different concentrations of the substances absorbing the radiation.

In certain embodiments, the fluid absorption medium employed can be a gas, such as oxygen.

Various methods can be employed to generate the desired differences in the concentration of the substances absorbing the radiation. On the one hand, it is possible to feed the different channels from different sources for the absorption medium circulating therein. However, a more variable approach can involve a dosage metering device assigned to one or several channels for feeding the substance absorbing the radiation into a carrier medium. Such dosage metering devices can be either pumps or microdispensers. In some embodiments, the substances absorbing the radiation can be fed via dosage metering systems such as those known from ink-jet printing. The latter have the advantage that the integral quantity of the substances absorbing the radiation can be controlled in an especially precise manner.

If a gas is employed as the absorption medium, the transmission of the filter element can be adjusted by altering the gas concentration and/or the partial pressure of the gas. If a channel system with separate channels is employed, the partial pressure and/or the gas concentration can be set for each individual channel developed with valves for instance, such that a filter element is developed with spatially adjustable transmission.

For an especially simple configuration of the filter in accordance with the disclosure it is possible to work without a channel system and to simply develop the flow of the fluid medium between two filter cover plates. However, it should be noted that in this case the desired local differences in the absorption properties of the fluid absorption medium may become blurred due to diffusion effects. This effect can be counteracted to a certain degree by adjusting the flow velocity accordingly.

In some embodiments, a filter or an optical element with a variable transmission can be established by a fluid medium, wherein the fluid medium is excited by known optical or micromechanic methods to a periodic structure providing for a fluid grating. For example by ultrasonic waves, standing waves within the fluid medium can be created. This provides for a periodic structure in the optical properties of the fluid medium. A so called fluid grating is generated. By the periodic structure of the fluid grating radiation impinging thereon is diffracted. As shown, for example, in U.S. Pat. No. 6,081,319 by diffraction at the periodic structure the intensity can be adjusted depending from the wavelength of the periodic structure and the amplitude of the periodic structure. The wavelength of the periodic structure and the amplitude of the periodic structure can be influenced by a generator exciting the waves in the fluid medium. Such a generator is, for example, an ultrasonic generator.

By creating an optical grating in a fluid medium by varying the density of the fluid medium, for example, by ultrasonic waves as described above with a fluid grating filter a desired shape of light intensity distribution can be provided. This is described in detail in U.S. Pat. No. 6,081,319, the contents of which are incorporated by reference herein in their entirety. By altering the density in a fluid the light passing through the filter is diffracted. The grating filter based on a fluid or gas works, because by changing the density of the fluid medium within the transparent body the optical properties of radiation impinging on the filter are changed in a periodic manner. The optical properties which could be changed could be the transmission, the reflectivity or the polarization.

In order to change for example the transmittance of a filter with a fluid medium according to the disclosure, in a carrier medium, such as, for example, purified water, particles especially metal particles can be suspended. The particles, for example, lower the transmittance in areas in which they are enriched. By adjusting the concentration of particles in the carrier medium therefore the transmittance can be adjusted.

Particles can be, for example, metal particles such as Ag-particles or metal-oxide particles such as TiO₂. Particles such as TiO₂ have the further advantage, that they very strongly absorb, for example, light with a wavelength in the UV-region. In a further embodiment the transmission in a fluid medium can be locally adjusted, if, for example, a suspension of two fluids is used. For example in a first phase at a first temperature the suspension can be a homogenous suspension of water and oil. If the temperature is lowered the suspension becomes inhomogenous, since the oil separates. A system like the described water/oil system can be used for adjusting the transmission, for example, by adjusting the temperature. The advantage of such a system over, for example, a suspension containing metal particles would be that stray effects which result, for example, from the metal particles could be lowered.

Furthermore, it can be desirable to adjust the refraction index of the absorption medium to that of the filter material. The principle of the filter in accordance with the disclosure can be adapted to diverse wavelength ranges used in lithography. With the application of expert knowledge not only the material for the filter but also an appropriate absorption medium can be selected as a function of the wavelength employed. Typical wavelengths for lithography facilities are for instance the mercury vapor G and I lines at 436 nm and 665 nm, respectively, and common wavelengths of eximer lasers, such as 248 nm (KrF), 193 nm (ArF) and 157 nm (F2). The application of the filter in accordance with the disclosure is also feasible for even smaller wavelengths, such as wavelengths in the EUV-region between 10 nm and 20 nm.

It can be desirable for the fluid medium, when changing the optical properties, such as transmittance, reflection or polarization, of light impinging onto the optical element to flow continuously through the filter. In this way it is possible to match, for example, the absorption characteristic of the filter to changes in the illumination system. This can be desirable, for instance, due to the modification of the selected illumination setting or to a thermally-initiated change in the alignment of the illumination system or the subsequent projection system. In an another embodiment by a medium having influence onto the polarization of light impinging onto the optical element, the polarization of the light can be adjusted. As mentioned above a fluid medium, which has influence onto the polarization can be for example a liquid crystal.

It is also feasible to design the filter such that the flow of the fluid medium especially for example an absorption medium is temporally discontinuous, i.e. the medium is only replaced upon demand following a change, for example, in the local absorption characteristic, resulting in a flow through the filter.

If the flow of the medium through the filter is temporally continuous, another subsequent advantage is that the medium exposed to the illumination radiation is constantly being removed and replaced, renewing the substances absorbing the radiation. This can prevent bleaching of the fluid medium and the filter maintains the desired characteristic such as absorption characteristic. This dispenses with replacing the filter components, either due to the need to adjust the filter characteristic or due to extended use, which for short wavelengths in particular tends to erode the material of a static filter.

If the filter in accordance with the disclosure is designed with a channel structure for a medium, for example, an absorption medium in the body of the filter, it is possible to influence the absorption characteristic across the filter surface via the channel system design. In the simplest case, a variation in absorption in a direction perpendicular to the scanning direction for a scanning lithography system, it is advantageous to align the channels for the absorption medium in the scanning direction. As adjacent channels should be separated by a channel wall, it is also desirable to have at least two bands of channels arranged parallel, with the channels of a first band being so displaced with respect to those of a second band perpendicular to the scanning direction that the radiation over the entire surface of the filter passing through the filter passes through at least one channel. Accordingly, this provides an arrangement whereby one channel of the second band is arranged below the intermediate zone of the channels of the first band such that the channels overlap with respect to the direction of the radiation passing through the filter. Embodiments are also feasible whereby more than two of these levels are arranged one after the other in the direction of radiation transmission. Furthermore, it is also feasible to combine a plurality of the filters in accordance with the disclosure into a filter system.

In general, the channels for the absorption medium need not be the same size nor arranged parallel. Consequently, it is also feasible to arrange a plurality of staggered and crossed bands such that the absorption characteristic can be adjusted virtually limitlessly across the filter surface.

For example in order to influence the polarization of the light, for example, in an lithographic apparatus it is possible to use an element, which can influence the polarization of the light impinging thereon, for example, a solid state polarizer before or after or as part of the optical element including a fluid medium according to the disclosure. By such a system the transmission as well as the polarization can be influenced.

In the present application the term fluidity is defined with respect to a medium in a broadest sense. This encompasses a broad range of viscosities of a fluid medium such that not only gases but also liquids and gel-like substances are included as fluid media in the sense of the application. A fluid medium in the sense of this application can for example be a liquid and/or a gas, a mixing of a liquid with a gas, a mixing of different liquids, a suspension including an insoluble liquid.

The disclosure is now described exemplary with respect to the drawings without being restricted thereto.

### BRIEF DESCRIPTION OF THE DRAWINGS

FIG. 1 is a schematic representation of an embodiment of an optical element in accordance with the disclosure.

FIG. 2 is a further schematic representation of an embodiment of an optical element in accordance with the disclosure with a channel system for the absorption medium.

FIG. 3 is a schematic representation of an embodiment of an optical element in accordance with the disclosure employing crossed channels in two planes.

FIG. 4 is an embodiment of an optical element through which a gas flows.

FIG. 5 is a schematic representation of an alternative optical element in accordance with the disclosure; a desirable application of which is as a pupil filter.

FIG. 6 shows a schematically simplified lithography system with an illumination system.

FIG. 7A-B show a schematic representation of an alternative optical element in accordance with the disclosure, a desirable application of which is as a field filter.

FIG. 8 represents a field illuminated on the field plane by the illumination system in the form of an annular field segment.

### DETAILED DESCRIPTION

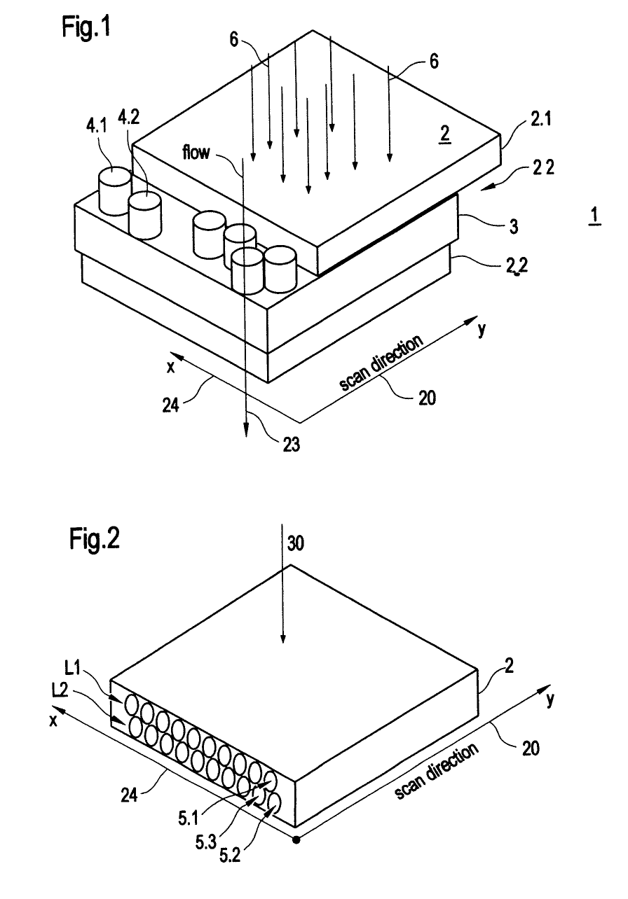

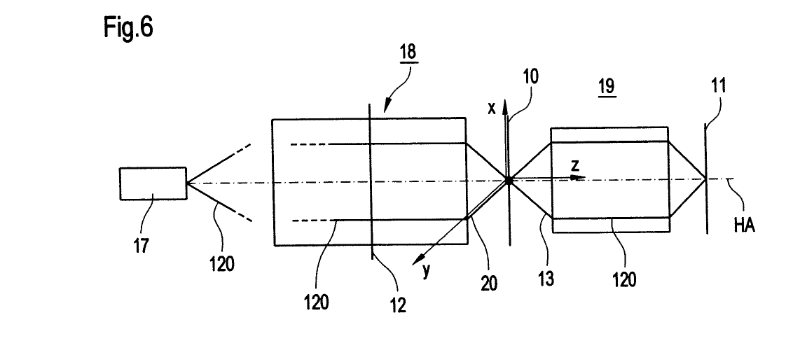

In FIG. 1-FIG. 5 and FIG. 7A-FIG. 8 embodiments of the optical element are described. A lithographic apparatus including an illumination system with such an optical element is described with regard to FIG. 6.

FIG. 1 shows an optical element for example a filter 1 which can be employed in an illumination system according to the disclosure. The optical element, for example, the filter 1 is provided with a basic filter body 2. The basic filter body 2 is at least partially a hollow body as described hereinafter. Optionally, the basic filter body is an essentially transparent material with respect to the radiation 6 of the illumination system impinging onto the filter. In FIG. 1, the basic filter body 2 includes two essentially parallel plane panels 2.1 and 2.2, separated such that they form a cavity 22 in the basic filter body 2 that is filled with a liquid medium 3. In some embodiments, the liquid medium can be an absorption medium, which provides for absorption of at least a part of the illumination radiation 6, thereby influencing the transmittance of radiation 6 impinging onto the filter. For the sake of simplicity, the lateral boundary for the fluid medium 3 is not depicted in FIG. 1. It can be developed by a man skilled in the art.

In the present application the term fluidity is defined with respect to a medium in the broadest sense. This encompasses a broad range of viscosities for a fluid medium, especially an fluid absorption medium. A fluid medium can be a gas, liquids and gel-like substances and mixing of different of these liquids and/or gases and/or suspensions in the sense of the application.

Furthermore, with respect to the present application the term fluidity also encompasses systems in which only the substances absorbing the radiation, for example ions, are mobile in an otherwise essentially stationary fluid or gaseous medium.

In certain embodiments, the fluid medium can include a carrier medium as well as a medium, which influences the radiation, for example, the transmission, reflection or polarization of the radiation impinging onto the optical element. For example particles, such as metal particles in water as a carrier medium can influence the transmission of radiation impinging onto the optical element, solely by controlling or adjusting the density of the metal particles within the carrier medium. For example in areas in which the density of the particles is high, the transmittance is low. In areas in which the density of the particles is low, the transmittance is high. If in such a medium the density of the particles corresponds to a periodic structure then a grating filter element as described in U.S. Pat. No. 6,081,319 is provided. Radiation impinging on such a filter will be diffracted as described in U.S. Pat. No. 6,081,319, which is incorporated herein by reference in its entirety. The density of the metal particles could be influenced by ultrasonic waves with the aid of an ultrasonic generator. The influence of the density is described with respect to metal particles in a suspension. As described above, this is only an exemplary embodiment and should not be understood as an limitation.

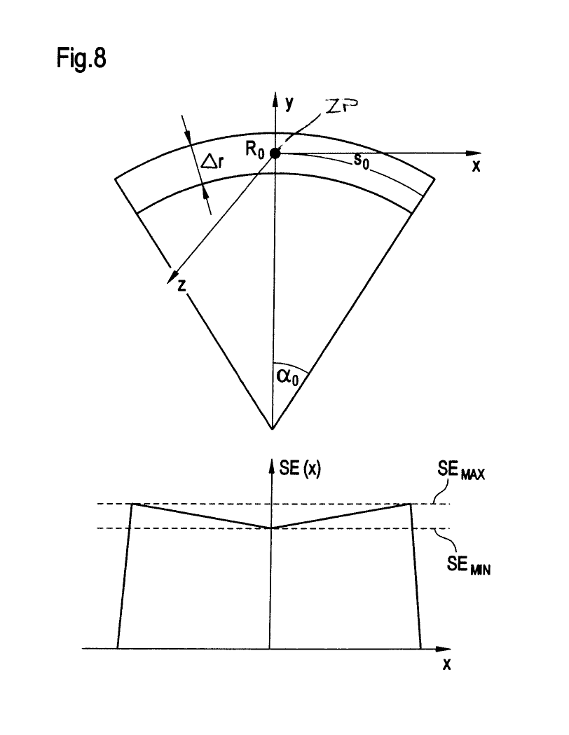

FIG. 1 also depicts a preferred direction, which for instance designates the scanning direction 20 for a scanning lithography system and therefore the direction of the movement of a mask in the field plane of an illumination system. As shown in FIGS. 6 and 8, the scanning direction 20 coincides with the y axis of an x, y and z coordinate system defined in a field plane of an illumination system as shown, for example, in FIG. 6. In the present embodiment the flow direction of the fluid medium, for example, the absorption medium is essentially in scanning direction. Furthermore, dosage metering devices 4.1 and 4.2 are depicted. These devices allow the absorption properties of the absorption medium to be modified at spatially different points. This can be performed either by controlling the introduction of different absorption media or via a controlled addition into the fluid medium 3 of substances absorbing the radiation 6. Possible embodiments therefore are pumps or valve systems, optionally miniaturized, or microdosage systems such as those known for instance as open-jet dosage systems from the field of ink-jet printers. Precise quantities of the substances absorbing the radiation can be metered into a carrier medium in the form of microdroplets. This process is defined both temporally and spatially via the arrangement of the dosage metering systems and the corresponding controls. A carrier medium is embedding a substance absorbing radiation.

Between the removal of the medium in the direction of flow and by controlling for example the absorption properties of the medium, varying absorption properties can be adjusted perpendicular to the direction of flow 22. In particular, this is also possible in direction 24 perpendicular to the scanning direction 20. Direction 24 coincides with the x-axis and direction 20 with the y-axis of the local x, y and z coordinate system in a field plane as shown in FIG. 6. No lateral boundary structures are shown in FIG. 1 within the layer of the fluid medium 3, so the differences, for example, in the absorption properties developed in the vicinity of the dosage metering devices 4.1 and 4.2 become blurred due to the diffusion effects in the downstream direction. In order to counteract this effect it is also possible to develop single flow channels for the fluid medium 3 in the basic filter body 2.

A system with single flow channels is shown schematically in FIG. 2. Two levels of channel systems are shown, with the channels arranged essentially parallel in each level. It is also shown that channel 5.1 in the first level L1 is staggered with respect to the adjacent channels 5.2 and 5.3 in the second level L2 such that their projections onto a plane perpendicular to the direction of illumination 30 overlap each other. The direction of illumination is defined in this case as the direction of a centroid beam of a light beam, for example, in an illumination system as depicted in FIG. 6. Staggering the channels in the different levels means that across the entire surface of the filter the illumination light passes through at least one of the channels filled with fluid medium, for example, absorption medium.

At the same time it can also be ensured that by arranging the flow channels for the fluid medium in layers it is possible to achieve projection crossover, without developing a fluid coupling between the individual channels.

The single channels 5.1, 5.2 and 5.3 shown for the filter in FIG. 2 are arranged parallel to each other in a scanning direction 20 in a lithographic apparatus. A system according to FIG. 2 can be used as a field filter in or near a field plane of an illumination system in order to influence the illumination and therefore the uniformity in the field plane. As in FIG. 1, the direction perpendicular to the scanning direction is designated as 24.

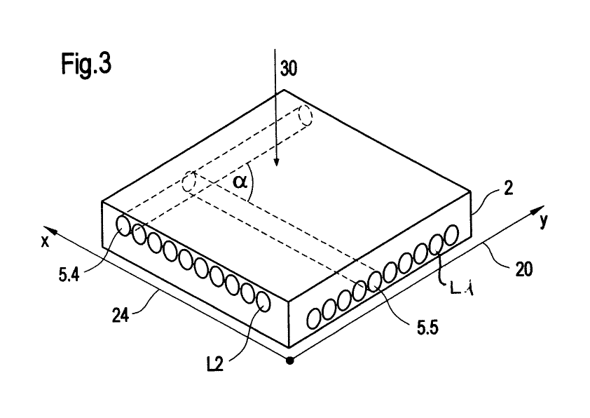

In FIG. 3 a fluid filter with channels is shown. The channels represented by the two fluid channels 5.4 and 5.5 are provided in two different levels L1, L2. The fluid channels 5.4, 5.5 are crossing at a right angle. This is advantageous, but not necessary. The fluid channels 5.4, 5.5 can cross also under another angle α for example under 45° or under 60°. In FIG. 3 the individual directions are given the same reference numbers as above. In FIG. 3, 20 denotes the scan direction, the so called y-direction and 24 the direction perpendicular to the scan direction, the so called x-direction.

A filter according to FIG. 3 with crossed channels in different levels can be used optionally as pupil filter in or near a pupil plane in order to influence the illumination in a pupil plane of the illumination system. A filter with which an illumination in a pupil plane can be influenced is shown, for example, in EP 1 349 009. A filter according to FIG. 3 can be used instead of the optical element which influences the pupil illumination shown in FIG. 6 of EP 1 349 009 in a microlithography exposure apparatus showed in that application. The contents of EP 1 349 009 are incorporated herein in their entirety.

Owing to the manifold options for settings for two or more levels with channels in the basic filter body 2, it is possible to develop spatially different absorption characteristics on the filter. Furthermore, the absorption characteristic can be modified in a variable manner due to the fluidity of the absorption medium. On the one hand this can occur by initiating a flow of absorption medium for each alteration that should be made to the absorption characteristic and by the refilling of the corresponding channels in the basic filter body 2 being performed in such a way that the spatial arrangement of the absorption medium fulfils the desired filter characteristic. On the other hand it can be desirable when the fluid medium is continuously being replaced, i.e. the fluid medium is flowing permanently through the filter. This can occur for instance in a circulatory system or the fluid medium is deemed as used after passing through the filter and is replaced or recycled accordingly.

Some embodiments employ ions as an absorption medium in a carrier medium, with highly purified water for instance being used as the carrier medium. Ions have the advantage that a force can be exerted upon them via electrical fields. If the ions move or are moved with the carrier medium, magnetic fields might also be used for this purpose in combination with electrical fields This has the advantage that in addition to or independent of transmission medium movement, the ions themselves can be influenced and consequently also those substances responsible for the absorption of the radiation. By arranging the electrodes accordingly, it is now possible to control the ion distribution and therefore the absorption characteristic of the filter in accordance with the disclosure.

Although all embodiments in FIGS. 1 to 3 are described with regard to a fluid medium, which influences, for example, the transmittance of a radiation impinging onto the optical element, especially the filter 1 it should be understood, that the embodiments shown could be used for all fluid media, which can influence optical properties of light impinging onto the filter. For example these devices could also be used for fluid media influencing polarization or reflectivity of light impinging onto the optical element, for example the filter.

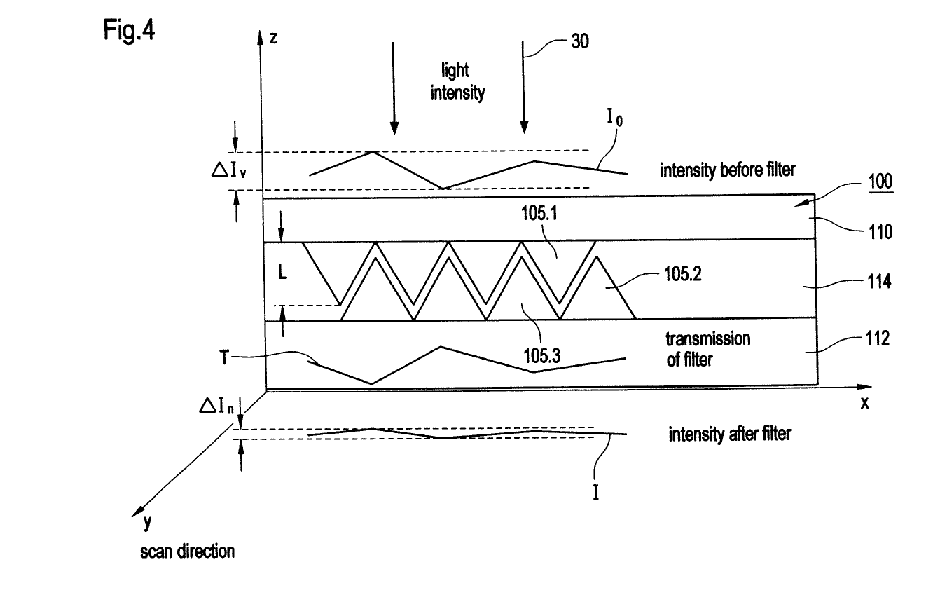

FIG. 4 shows an optical element, especially a filter in accordance with the disclosure, with a gas subject to a certain partial pressure being employed as the fluid medium, with which the transmittance of a light beam impinging onto the filter can be influenced. Oxygen subject to a certain partial pressure is an exemplary gas.

The filter shown in cross-section in FIG. 4 perpendicular to the scanning direction, i.e. in the x,z-plane of the local coordinate system in the field plane, and part of a projection exposure system, the basic structural design of which is shown in FIG. 6, includes a transparent body 100 with triangular channels 105.1, 105.2 and 105.3, through which the gas flows. A filter such as that shown in FIG. 4 can be developed using three elements made of CaF₂. In this case an upper flat panel 110 and a lower flat panel 112 enclose an element 114, which encompasses the three triangular channels 105.1, 105.2 and 105.3. The element that encompasses the three triangular channels 105.1, 105.2, 105.3 is also known as the zigzag element. The zigzag element 114 can be developed by making laterally staggered V-shaped grooves in a crystal, for instance with an unisotopic etching rate. If these V-shaped grooves are covered by an upper flat panel 110 and a lower flat panel 112, this results in the triangular channels 105.1, 105.2, 105.3 shown. As previously, the direction of the incident light is indicated by the reference number 30. The ways in which the transmission of a filter represented in FIG. 4 can be varied will now be described below.

As indicated by the following formula, the transmission is a function of the partial pressure and/or the absorbency of the gas:

where:

$$T = \frac{I}{{I}_{o}} = {e}^{- σ \frac{pL}{{KT}_{abs}}}$$

### T: Transmission

I: Intensity after the filter
I₀: Intensity before the filter
σ: Absorption cross-section, function of gas concentration [l/m²]
p: Partial pressure [Pa]
L: Light path through the gas [m]
K: Bolzmann constant [J/K]:
T_{abs}: absolute temperature [K]

The following embodiment provides an estimation of how the transmission changes when the partial pressure p [Pa] changes, while the O₂ concentration is maintained constant at a concentration of 1000 ppm. The transmission was calculated for a wavelength of 157 nm. The data are as follows:

σ=5.2*10⁻²²/m²*O₂ concentration (for oxygen at 157 nm)
O₂ concentration=1000 ppm (constant)

### L=0.001 m

### K=1.38*10²³ J/K

### T_{abs}=295K

The resulting transmission T of the filter is shown in Table 1 for the various partial pressures p.

TABLE 1

| | |
|---|---|
| Partial pressure | Transmission |

| | | | |
|---|---|---|---|
| p = | 0 Pa | T = | 100% |
| p = | 50662 Pa | T = | 99.35% |
| p = | 101325 Pa | T = | 98.71% |
| p = | 151987 Pa | T = | 98.08% |

As indicated by Table 1, the transmission can be modified by changing the partial pressure. As it is possible to adjust the partial pressure for each individual channel 105 of the filter element, as shown in FIG. 4, for instance via a control unit, the optical element can be used to vary and set the transmission locally perpendicular to the scanning direction, i.e. along the x-axis, influencing the uniformity of illumination in a field plane, as shown in FIG. 6. The modifications of the transmission therefore effect the longintudinal side of for example a slit like field, whereas the transverse side is not influenced. Instead of adjusting the partial pressure, the partial pressure can also be held constant and the gas concentration can be altered. In the described case the gas concentration, which is altered is the oxygen concentration. This is shown in the following embodiment. The parameters of the embodiment are as follows:

σ=5.2*10⁻²²/m²*O₂ concentration (for oxygen at 157 nm)
P=101325 Pa constant

### L=0.001 m

### K: =1.38*10⁻²³ J/K

### T_{abs}=295K

The resultant transmissions I for the various oxygen concentrations are shown in Table 2 for a constant partial pressure of 101325 Pa.

TABLE 2

| | |
|---|---|
| Oxygen concentration | Transmission |

| | | | |
|---|---|---|---|
| O₂ | 0 ppm | T = | 100% |
| O₂ | 500 ppm | T = | 99.35% |
| O₂ | 1000 ppm | T = | 98.71% |
| O₂ | 1500 ppm | T = | 98.08% |

As shown by Table 1 and Table 2, transmission by the filter can be influenced by the appropriate regulation of the O₂ concentration and/or the partial pressure, thus influencing the range of intensity in the light path.

In particular, the location-dependent variation Δlᵥ of the intensities I₀ before and I after the filter can also be influenced, in particular the variation can be reduced, as shown in FIG. 4. Consequently, the filter makes it possible to compensate for location-dependent variations in intensity, achieving the most uniform range of intensity I possible after the filter.

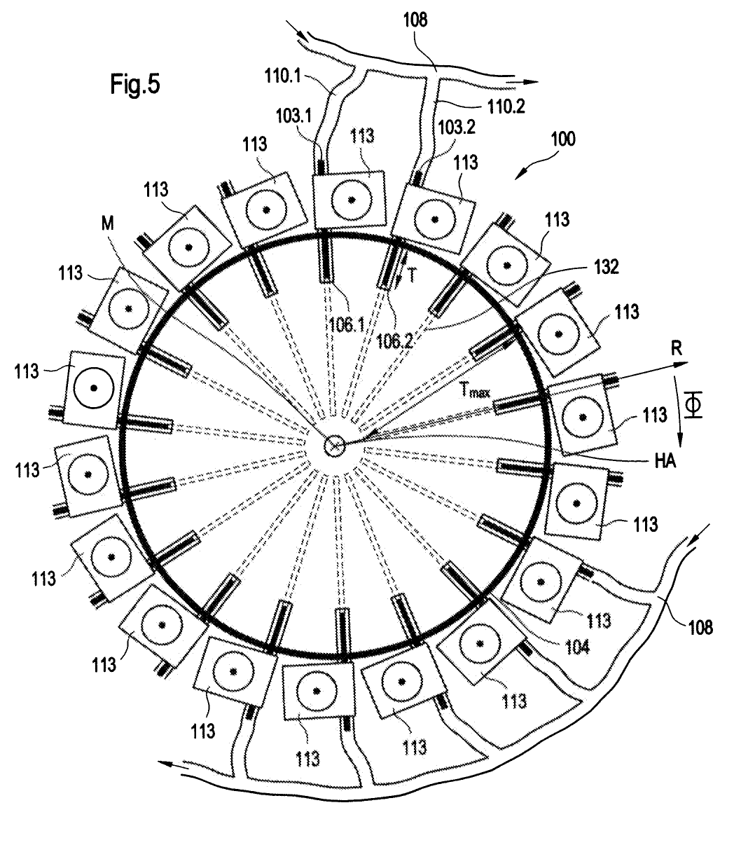

FIG. 5 shows an optical apparatus, a so called filter apparatus in accordance with the disclosure. An alternative embodiment includes a plurality of individual optical elements, especially filter elements 103.1, 103.2, which can be inserted into the light path of an illumination beam of an illumination system of a microlithography projection exposure system. The illumination beam passes through the projection exposure system from the light source to the plane in which, for example, a light sensitive substrate is situated. The plane in which the substrate is situated is also designated as image plane. The microlithography exposure system includes an illumination system which collects and shapes the radiation of the light source in order to illuminate a field in a field plane of the illumination system. The inventive optical elements as described above are situated in a light path of a radiation passing through the illumination system from the light source to the field plane.

A microlithography projection exposure apparatus with an illumination system in a general view is depicted for instance in FIG. 6. Optionally, the individual filter elements 103.1, 103.2 are hollow bodies through which a fluid flows. The fluid in the hollow bodies 106.1, 106.2 is fed into the individual hollow bodies 106.1, 106.2 from an external source, for instance via a ring main line 108 and for instance flexible lines 110.1, 110.2. The fluid in the hollow bodies serves as a medium, with which the optical properties of light impinging onto the filter apparatus can be influenced. For example, with a fluid including particle, which flow through the individual filter elements 103.1, 103.2 the transmission of light could be influenced. Each of the flexible lines 110.1, 110.2, could be equipped with a device for dosage control, such as e.g. micropumps. By controlling the dosage e.g. of an absorption-medium the transmittance can be locally adjusted as described in the application.

For the filter apparatus according to FIG. 5 a radial direction R and an azimuth direction Φ are shown. The filter apparatus shown in FIG. 5 is optionally employed as a pupil filter, as described in DE 10 2004063314.2, filed on Dec. 12, 2004, and/or PCT/EP2005/09165, filed on Aug. 25, 2005, the contents of both of which are incorporated herein in their entirety. If the filter apparatus is used as a pupil filter, the apparatus is located in or near a pupil plane of the illumination system. The advantage of a filter apparatus according to FIG. 5 for correcting the illumination in a pupil plane is, that the pupil illumination is less deformed than in mechanic systems.

If the filter described in accordance with FIG. 5 is employed in or near a pupil plane 12 conjugated to the exit pupil 13 of the illumination system. The Fourier transformed image of the field is developed in this plane and manipulation of the intensity distribution in a pupil plane influences the distribution of the angular spectrum of the field. Consequently, with this arrangement the filter in accordance with the disclosure functions as a spatial filter.

In order to discuss an illumination system including optical elements as described before or hereinafter a simplified schematic representation of a lithography system is shown in FIG. 6. The figure shows a light source 17, an illumination system 18 and a projection objective 19. Not only the illumination system 18, but also the projection objective or projection lens 19 typically includes a plurality of optical components (not shown in detail) arranged around an optical axis HA for a refractive system as e.g. for 193 nm lithography. The simplified sketch shown in FIG. 6 does not show details such as individual optical components. Only outlined is a light path 120. The light path 120 includes radiation emitted by the light source e.g. with a wavelength of e.g. 157 mm or 193 nm. With the aid of an illumination system 18 a field in an object plane 10 is illuminated. An example for such a field is shown in FIG. 8. The object, for example, a mask is projected by a projection objective 19 into an image in an image plane 11.

Typically, a reticle is arranged in the object plane 10 and a photoresist-coated wafer in the image plane 11, both of which are transported in synchronization with each other in the scanning direction in a scanning system. The scanning direction in a scanning system is the y orientation. FIG. 6 shows the local x, y, z coordinate system of the object plane 10, the origin of which coincides with the central field point of the field to be illuminated, such as shown for instance in FIG. 8.

Depending on the task of the optical element, the optical element is situated in the light path of the illumination system 18 in different locations.

If the optical element in accordance with the disclosure is used as a pupil filter, e.g. as shown in FIG. 5 than the filter is situated in or near a pupil plane 12 of the illumination system. A pupil plane 12 is for example a plane, which is conjugated to the exit pupil of the illumination system, which corresponds to the entrance pupil of the projection lens 19. With respect to further embodiments of pupil filters, reference is made to DE 10 2004 063314.2, filed on Dec. 23, 2004, and EP 2005/009165, filed Aug. 25, 2005, the contents of both of which are incorporated by reference herein in their entirety.

The object plane 10 of the projection objective is also simultaneously the field plane of the illumination system 18 in which a field is illuminated. If a fluid field filter in accordance with the disclosure is used then such a field filter is arranged in the light path 120 from the light source 17 to the field plane 10 of the illumination system in or near the field plane 10. Arrangements are also possible in planes or near planes conjugated to the field plane. Furthermore, the filter in accordance with the disclosure can also form part of the optical components of the projection objective 19.

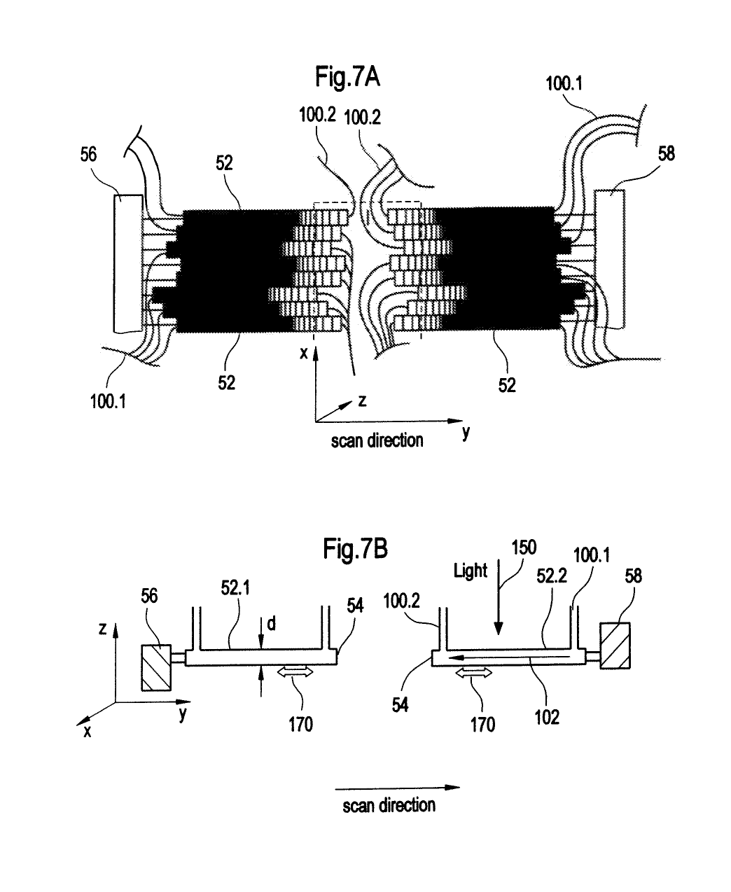

An embodiment of an optical element, which can provide for a fluid field filter is, for example, shown in FIG. 7A-7B.

In FIG. 7A-7B an example for an optical element which can serve as a fluid field filter is shown. The field filter is arranged as close as a possible to a field plane, for example directly in front of an image plane of a masking objective. The purpose of the field filter is to adjust and, in particular, to homogenize the illumination dose on an photosensitive layer in the image plane 11 of the projection lens. An embodiment of a mechanical field filter, a so called adjusting instrument is described in WO 2005/040927, the contents of which are incorporated herein in their entirety.

According to FIGS. 7A and 7B the fluid filter includes a multiplicity of movably arranged stop elements 52. These are designed as finger-like rods which, in the exemplary embodiment represented in FIGS. 7A and 7B, face one another in a cantilevered fashion in various planes. The stop elements 52 are divided into two mutually opposing groups, within which they respectively adjoin one another along their longitudinal sides and can be displaced individually in scanning direction, here the y-direction. By displacing the stop elements 52 in scanning direction the field perpendicular to the scanning direction can be adjusted. Drive units 56, 58 (not represented in detail) as are described in EP 1 020 769 A2, for example, are used for this.

The drive units 56, 58 are in this case controlled in such a way, that two stop elements 52 facing one another can be displaced synchronously in opposite directions. In this way, it is possible for free ends 54 of the stop elements 52 to be displaced into the projection light beam so as to modify for example the shape of the slit-shaped light field already defined by a masking unit in case of 193 nm lithography in x-direction is influenced. The modifications effect the longitudinal side of for example a slit like field, whereas the traverse side is not influenced.

The rod-shaped stop elements 52 each have a continuous transmission as represented as grey values in FIG. 7A. Each of the stop blades 52 is a hollow body 52.1, 52.2 with a fluid medium inside the hollow body. The fluid medium with e.g. absorbing particles is fed to each hollow body via a line 100.1. The fluid medium flows through the hollow body and towards line 100.2 along arrow 102. The fluid leaves the hollow body 52.1 through line 100.2. By influencing e.g. the concentration of absorbing particles in various areas of the hollow body the transmission can be adjusted as shown in FIG. 7A. In the embodiment shown in addition to adjusting the transmission by the fluid media, the hollow bodies 52.1, 52.2 can be mechanical moved as described before in order to influence a field in a field plane. The hollow body has a thickness d.

A line 100.1 for feeding the fluid media to the hollow body and a line 100.2 for fluid media leaving the hollow body is associated to each of the hollow stop elements 52. The lines 100.1 and 100.2 can lead to a common line 200.1, 200.2, which provides, for example, fluid for each individual line 100.1.

The direction under which light or radiation impinges onto the optical element is designated with 150.

The intensity distribution of the illuminated field on the field plane can be influenced via an optical element as described in FIGS. 7A and 7B₁ especially a filter in accordance with the disclosure arranged in the light path between the light source and the field plane and in particular in the vicinity of the field plane. In order to influence the intensity distribution in the field plane the stop elements are displacable individually in a direction 170. The direction in scan-direction is the y-direction. x- and y-direction are depicted in FIG. 7A.

The optical element shown in FIG. 7 and 7B can be easily modified and then provide for an optical element which can be used as a pupil filter, such as described in EP 1 349 009. In order to provide for a pupil filter a further set of parallel stop blades is arranged movable in a y-direction in addition to the stop blades provided movable in a x-direction. The additional stop blades can also be situated under an angle with respect to the stop blades 52 oriented in x-direction. For example the additional stop blades can be oriented with respect to the stop blades 52 under an angle of 45° or 60° without being restricted thereon. Such a pupil filter is similar to the pupil shown in FIG. 3. With such a pupil filter the edge of a pupil illumination could be influenced and therefore adjusted. Such a pupil filter can be used in a projection exposure apparatus as described in EP 1 349 009.

In order to present how the illumination intensity of a field in the field plane of an illumination system can be homogenized by a filter element in accordance with the disclosure, the concept of field illumination uniformity will be discussed with reference to FIG. 8 without being restricted thereon.

The characteristic quantities for an illuminated field in the field plane in the form of an annular field segment are shown in FIG. 8. Consequently, the width of the annular field segment is Δr and the mean radius is R₀, representing the distance to the optical axis of the projection objective. An angular range of

2×α₀

and/or an arc of

2×s₀

is scanned. The local x,y,z coordinate system is shown at the central point ZP of the annular field, with the scanning direction extending parallel to the y axis of the coordinate system. The scanning energy SE is calculated as follows as a function of the axis x perpendicular to the scanning direction:

SE(X)=∫E(x,y)dy

where E as a function of x and y is the intensity distribution in the reticle plane defined by the x and y axes. If one wishes to achieve uniform exposure it is advantageous when the scanning energy is largely independent of x. Consequently, uniformity in the scanning direction is defined as follows:

Uniformity [%]=100%*(SEₘₐₓ−SEₘᵢₙ)/(SEₘₐₓ+SEₘᵢₙ)

where
SEₘₐₓ: Scan integrated energy maximum
SEₘᵢₙ: Scan integrated energy minimum

The plot of the scan integrated energy (SE(x) as a function of the x position is shown as an example in FIG. 8 below the illuminated field as well as the values SEₘᵢₙ and SEₘₐₓ.

Without correction the scanning energy increases in the field plane toward the field boundary as the scanning path increases in this direction. If a filter in accordance with the disclosure is arranged in or in the vicinity of the field plane or in or in the vicinity of a plane conjugated to the field plane, the absorption characteristic can be adjusted perpendicular to the scanning direction to improve uniformity as the intensity distribution can be influenced along the x axis. In this case in particular a filter such as that shown in FIG. 4 or FIGS. 7A and 7B comes into consideration for the fluid filter.

Further an optical element with a fluid medium according to the disclosure can function as a polarizer, when brought into the light path from an object plane to an image plane.

The optical element can also be combined with the conventional polarization situated in the light path.

A fluid filter such as that shown in FIG. 5 comes into consideration as a pupil filter in particular.

The disclosure discloses for the first time optical element, especially a filter element that allows the intensity to be corrected locally in a simple manner, for instance by setting or regulating gas pressure and/or the concentration of a transmission medium. Optical elements of this kind can be employed not only as field filters but also as pupil filters in illumination systems for projection exposure systems, in particular for microlithography. In particular, the uniformity of illumination in the field plane as well as in the pupil plane and the polarization can be influenced.

What is claimed is:

1. An illumination system, comprising:
a source configured to emit the radiation, the source having a field plane in which a field is illuminated by the radiation;
an optical element including an at least partially hollow body, the at least partially hollow body being configured so that radiation emitted by the source impinges on the at least partially hollow body during use of the illumination system;
a fluid medium in the at least partially hollow body, the fluid medium being capable of at least partially influencing at least one optical property of the radiation impinging on the at least partially hollow body; and
a device configured to locally adjust the at least one optical property of the radiation that is at least partially influenced by the fluid medium,
wherein the optical element is arranged in or in the vicinity of the field plane or a plane conjugated to the field plane, and the illumination system is configured to be used in a microlithography exposure apparatus.

2. The illumination system according to claim 1, wherein the at least one optical property includes at least one optical property selected from the group consisting of transmission, reflectivity and polarization.

3. The illumination system in accordance with claim 1, wherein the fluid medium comprises:
a radiation absorbing substance; and
a liquid, gaseous or gel-like carrier medium.

4. The illumination system in accordance with claim 3, wherein the radiation absorbing substance has essentially the same refractive index as the hollow body.

5. The illumination system in accordance with claim 1, wherein the hollow body is at least partially transparent.

6. The illumination system in accordance with claim 1, wherein the fluid medium is a liquid.

7. The illumination system in accordance with claim 1, wherein the fluid medium is a gas.

8. The illumination system in accordance with claim 1, further comprising a system configured to guide the fluid medium, the system configured to guide the fluid medium being in the at least partially hollow body.

9. The illumination system in accordance with claim 8, wherein the system configured to guide the fluid medium comprises a plurality of guidance devices.

10. The illumination system in accordance with claim 9, wherein the illumination system has a scanning direction, and the plurality of guidance devices in one direction are arranged parallel to each other and perpendicular to the scanning direction of the illumination system.

11. The illumination system in accordance with claim 9, wherein the at least two of the plurality of guidance devices are arranged at angle to each other.

12. The illumination system in accordance with claim 8, wherein the plurality of guidance devices are channels.

13. The illumination system in accordance with claim 1, wherein:
the fluid medium comprises a carrier medium and a substance in the carrier medium, the substance being configured to absorb the radiation;
the optical element comprises at least one dosage metering device configured to adjust at least one parameter selected from the group consisting of a concentration of the substance in the carrier medium, a concentration of fluid medium, and a partial pressure of the fluid medium.

14. The illumination system in accordance with claim 1, wherein the fluid medium comprises an electrolyte and ions in the electrolyte, and the ions are capable of absorbing the radiation.

15. The illumination system in accordance with claim 14, further comprising a device configured to use an electrical field to influence the movement of the ions.

16. The illumination system in accordance with claim 1, wherein the fluid medium is configured to change a polarization of radiation impinging on the at least partially hollow body.

17. Illumination system in accordance with claim 16, wherein the fluid medium is a liquid.

18. The illumination system in accordance with claim 1, wherein a scanning direction of the illumination system is assigned to the field in the field plane, and the optical element is configured to influence a uniformity of illumination perpendicular to the scanning direction.

19. The illumination system in accordance with claim 1, wherein the illumination system has a pupil plane, and the optical element is in a path of the radiation in or in vicinity of the pupil plane or a plane conjugated to a pupil plane.

20. The illumination system in accordance with claim 1, wherein the optical element is a polarizer.

21. A system, comprising:
an illumination system, comprising:
a source configured to emit radiation, the source having a field plane in which a field is illuminated by the radiation;
an optical element including an at least partially hollow body, the at least partially hollow body being configured so that the radiation impinges thereon during use of the illumination system;
a fluid medium in the at least partially hollow body, the fluid medium being capable of at least partially influencing at least one optical property of the radiation impinging on the at least partially hollow body; and
a device configured to locally adjust the at least one optical property of the radiation that is at least partially influenced by the fluid medium; and
a projection objective configured to project an object in the field plane into an image,
wherein the system is a microlithography exposure apparatus.

22. A method, comprising:
using the illumination in the system in accordance with claim 21 to illuminate a mask in the field plane; and
using the projection objective to project the mask onto a photosensitive object to provide a microstructured device.

23. A system, comprising:
an optical element including an at least partially hollow body, the at least partially hollow body being configured so that radiation impinges thereon during use of the illumination system;
a fluid medium in the at least partially hollow body, the fluid medium being capable of at least partially influencing at least one optical property of the radiation impinging on the at least partially hollow body; and
a device configured to locally adjust the at least one optical property of the radiation that is at least partially influenced by the fluid medium.

24. An optical element, comprising:
an optical element including an at least partially hollow body, the at least partially hollow body being configured so that radiation impinges thereon during use of the optical element;
a fluid medium in the at least partially hollow body, the fluid medium being capable of at least partially influencing at least one optical property of the radiation impinging on the at least partially hollow body; and
a device configured to locally adjust the at least one optical property of the radiation that is at least partially influenced by the fluid medium
wherein the optical element is configured to be used in a microlithography exposure apparatus.
